(19) United States
(12) Patent Application Publication
(10) Pub. No.: US 2003/0158969 A1
(43) Pub. Date: Aug. 21, 2003

(54) Authoring of media content and dissemination via an information technology network

(76) Inventors: Roger Brian Gimson, Bristol (GB); Fabio Giannetti, Bristol (GB)

Correspondence Address: HEWLETT-PACKARD COMPANY, Intellectual Propety Administration, P.O. Box 272400, Fort Collins, CO, 80527-2400, US

(21) Appl. No.: 10/349,668

(22) Filed: Jan. 23, 2003

(30) Foreign Application Priority Data
Jan. 31, 2002 (GB) 0202340.6

(51) Int. Cl. G06F 15/16

(52) U.S. Cl. 709/246

(57) ABSTRACT

Content from a web page, such as text, music graphics etc. is assimilable by a plurality of classes of device, such as PDA, mobile phone and desktop computer. The content is initially authored to include machine readable structural information reflecting structure in the substance of the content, such as chapters, and instructions on the preferred manner the author wishes to see the content presented to the author. This structure is embedded in the content using a device independent markup language. The structured content is then filtered for different classes of device to remove aspects of the preferred presentation which are not possible to replicate on a particular class of device, and the markup code is then modified where appropriate to tranform and instructions not supported by the device on which the content is to be manifested. Finally and dynamic content, such as values which are context dependent, for example the time of day of accessing the web page are augment the adapted content, and final minor adjustments to the adapted content are made to account for the specification of the individual device requesting the content.

### BACKGROUND TO THE INVENTION

1. Field of the Invention

The present invention relates the authoring of media content, such as for example literary, musical or other forms of work, and to the dissemination of such content via an information technology network, such via the internet for example, to a variety of technically different devices which enable a user to assimilate such content.

It is currently possible to gain access to a web page using a number of different devices, such as a desktop or laptop computer, a personal digital assistant (PDA) in combination with a telephone and modem link, or directly to a mobile telephone by invoking a communication protocol known as Wireless Access Protocol (WAP). Thus, in principle, content posted on a web page, such as text and graphics is accessible by a consumer in possession of any one of these devices who is able also to avail themselves of the requisite network links. In practice however a significant but, to the lay person ostensibly trivial difficulty exists in disseminating content to all of these devices in a manner which is useable by a consumer: the device the consumer is using to make manifest the content may not be capable of manifesting elements of the content essential for comprehension of the information within it. Specifically for example a web page may not have been authored specially to enable viewing of its content via WAP, and therefore using a small, monochrome and extremely low resolution screen. If the author has therefore created the web page so that all or part of the essential information on the page required by the user is “coded” in the form of photographs, coloured text or animations, then a user who is unable to display these elements of the content on their screen will be unable to interpret their meaning, and is therefore effectively unable to access the page in any meaningful manner.

2. Description of Related Art

This problem is known, and is currently addressed in one of three ways. According to one approach, content for a web page (for example) is authored independently of a consideration of the device on which the content is to be made manifest, other than perhaps to the extent that the author attempts to encode all seminal information in a manner assimilable by even the crudest form of device. Once a request for a copy of the page is received, an adaptation process, performed by a programme which intermediates between the device requesting the page and the host device where the page is stored then takes place, in which an abridged version of the content appropriate to the class of the requesting device is extracted from the original data file for the page in question, and is sent to the requesting device. A second approach involves authoring the page using computer code to author the content which is specifically appropriate for a particular class of requesting device (for example using hyper-text markup language (html) to author web pages for consumption by conventional desktop or laptop computers), which may mean having to author the page several times in order to enable manifestation of the page on several differing classes of device. In what may be termed a sub-class of this approach, content authored in a language specifically appropriate for one device is transformed into a language specifically appropriate to another class of device, possibly resulting in an unwanted loss or alteration of content as a result (in a manner analogous to the result of translating, for example, a German document into English using computer software).

### SUMMARY OF THE INVENTION

The present invention provides an alternative approach, which enables a consideration of the effect of requirements of different types of device during the authoring process, and yet in which the content is authored without any expression of the manner in which it may be implemented on a particular class of device. Subsequent adaptation of the content for specific classes of device is then performed, to take account of factors which depend upon the requesting device, such as markup presentation of the content, layout (i.e. to take account of the size of the screen on which the content is to be displayed), interaction capabilities of the device, and the ability of the device to navigate through a series of links to other pages for example.

According to a first aspect of the present invention there is provided a method of disseminating media content, hosted at a site within an information technology network, to one of a plurality of different classes of device connected to the network, the different classes of device having different capabilities for manifesting the content, the method comprising the steps of:

authoring the content by at least structuring the content in a manner which is independent of device on which the content is to be manifested;

adapting the authored content to make the content suitable for manifestation on a given class of device;

storing the adapted content at a location within the network; and

upon receipt of a request for a copy of the content, augmenting the adapted content with dynamic content.

Dynamic content is typically content which changes in dependence upon the context, such as a railway timetable that may change depending upon the day of the week, and the augmentation of the adapted content with dynamic content is, according to one embodiment, a process in which simple data values, such as the times of trains on a given day of the week are input into the appropriate part of a document at a location predetermined by the structure of the document during authoring and the adaptation of the authored content for a specific class of device. The dynamic content data values may be retrieved from a location remote from the host, or from the host, for example.

The content may be of any media type capable of transmission over an information technology network, and manifestable on a device operably connectable to such a network, such as for example visually assimilable content (e.g. text, graphics, photographs, animated images or film clips for example), aurally assimilable content such as music, or content assimilable by tactile means, such as Braille.

Where the content is provided in legacy form, that is to say that pre-existing content, either which is not structured, or whose structure is coded either in a language or a form which is not device independent, the authoring process will typically comprise the step of translating the device dependent content structure into a device independent one. Alternatively authoring the content may comprise the steps of creating the content ab initio, and structuring it simultaneously in device independent form, either simultaneously, or subsequently.

Where content is to be created ab initio and structured either as part of a simultaneous process during the course of creating the content, or subsequently, it is advantageous to provide at least an indication of the way in which the content will be manifested on various classes of device. In a preferred embodiment of the invention, the adaptation process enables an author to view the content when implemented for a particular class of device during the authoring process, thus providing something akin to the capability of a WYSIWYG editor.

A second and independent aspect of the present invention provides a method of authoring content for hosting on a site within an information technology network to enable dissemination of the content to one of a plurality of different classes of device connected to the network, the method comprising the steps of:

authoring the content by at least structuring the content in a manner which is independent of device on which the content is to be implemented;

adapting the authored content to make the content suitable for manifestation on a given class of device; and

during the authoring process, manifesting at least a representation of manifestation of the content on a given class of class of device.

### BRIEF DESCRIPTION OF DRAWINGS

Embodiments of the invention will now be described, by way of example, and with reference to the accompanying drawings, in which:

FIG. 1 is a schematic illustration of the information technology network elements which play a part in an embodiment of the present invention;

FIG. 2 is a flow chart illustrating schematically at a high level operation of an embodiment of the present invention;

FIGS. 3a to 3e are illustrations of various sections of a web page authored to provide structure independent of device implementation;

FIGS. 4a and 4b show the structured content of FIGS. 3 with device independent layout instructions coded into it, and a resultant layout;

FIG. 5 is a diagram illustrating a first part of adapting the content into device-class specific form;

FIG. 6 is a flow chart illustrating a second part of a process of adapting the content into device-class specific form;

FIG. 7 shows the structured content following the adaptation process of FIG. 6; and FIGS. 8a and 8b are flow charts illustrating the process of adaptation of the content as structured in FIG. 7 for a specific device within a class.

### DESCRIPTION OF PREFERRED EMBODIMENTS

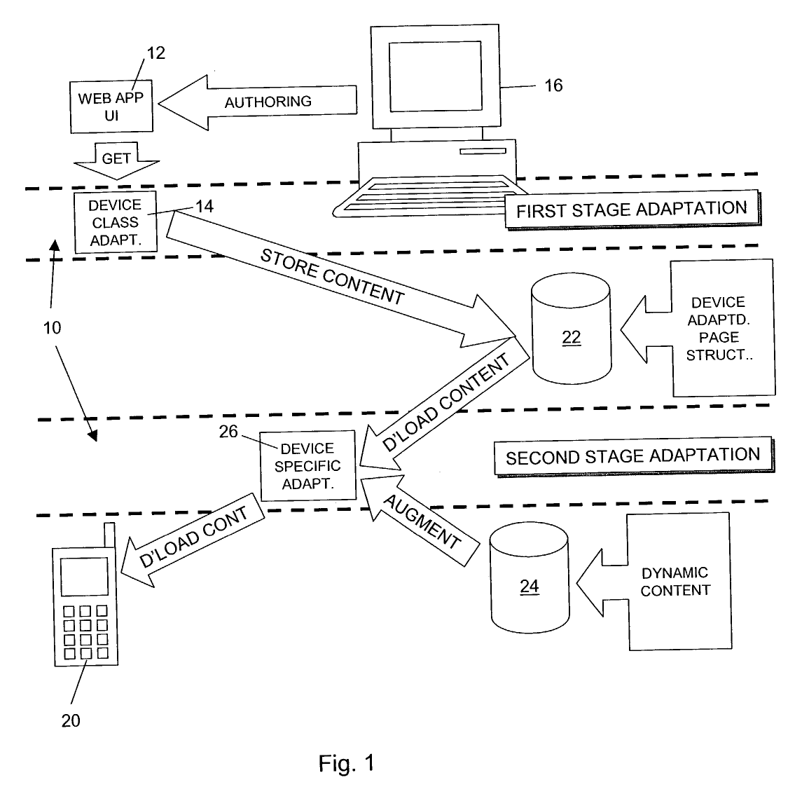

Referring now to FIG. 1 a computing entity within an information technology network includes a web application user interface 12 acting as a host for a web page, and a processing capability which runs a programme 14 for adapting the content of web pages to given classes of device on which the may be assimilated. In the present example this is provided by the processor (not shown) of the entity hosting the web page, although this is not essential and the processing capability may be provided by any suitable computing entity, and at any suitable location within the network. In the present example, the content of the web page is in the form of text (i.e. visual characters, usually alpha-numeric in any language), as the web page provides information on train times, and the opportunity to book a ticket. The content however could be in any media form consumable via the network, such as music, graphics, moving images such as film or video clips, or animations, or a book assimilable in tactile form via the network, for example in Braille. Within this specification, the term “content” is intended to encompass within its scope the artistic works such as graphic, literary, musical, dramatic or other type of work traditionally afforded copyright protection, the electronic files in which such works are recorded, and any machine readable structure incorporated within such files to enable their assimilation via, in this example, electronic means. Thus, for example in the case of a literary work, the content is both the words which comprise the work, the electronic files in which either the text, audio or Braille media via which those words are to be assimilated are recorded, as well as any electronically recorded instructions which provide structure to the files, for the purpose, inter alia of reflecting the structure of the works themselves in a form comprehensible to computers.

The role of what may be termed electronic structure is best illustrated by example, such as the case of a book having a number of chapters, and a device for assimilating the book via the medium of Braille which is incapable of storing the electronic file in which the Braille is stored in its entirety. If a download of the Braille file in which the words of the book are stored is requested using this device, the download will be interrupted at the instant the memory of the device is full, and at some point before the end of the book. In the absence of electronic commands or “tags” within the Braille file which denote, for example the locations of chapters of the book, it will be impossible for a user of the device ever to download the part of the book they were unable to download on the first occasion. This is because a further download request will once again start to download the entire book from the beginning, and will once again fail midway through at the same place in the book as a result of insufficient memory. Neither the requesting device or the computing entity hosting the book have any way of being able to establish which part of the Braille file was not downloaded, since electronically, the book does not have any chapters or other structure. Once machine readable structure (typically electronic) is incorporated within the file to reflect the actual structure of the book, it is possible for both the device and the hosting computing entity to establish that the download of, say the first five chapters of the book were successfully completed, and so to arrange on the second occasion to download chapters 6 et seq.

In the present example, the content of the web page is provided from an author 16, who is also connected to the network, although this is not necessary, and is entirely incidental from the point of view of the present invention. In this context the process of authoring the web page may include the provision of a number of the parts which comprise the total content. For example, in the case of a legacy system (i.e. one having pre-existing content) to which the methods of the present invention are to be applied, the content may be authored simply by translating the pre-existing electronic structure coded into the file storing the content into a more suitable form; authoring of the content may however additionally include other authoring steps, such as actually creating the artistic work, for example.

The authored content is then adapted, in accordance with various device class specifications to enable it to be appropriately manifested on devices within the aforementioned classes, such as, for example, on a desktop PC, on a Personal Digital Assistant (PDA) or on a mobile phone 20, as illustrated in the schematic illustration of the process shown in FIG. 1. Device-class specific adaptations of the content are then stored within the network, in the present example at a dedicated storage facility 22, although this storage may once again be located at any suitable location within the network, including within the host computing entity 10. Upon receiving a request for a copy of the page, which in the present example is a web page providing train time information and enabling booking of a train ticket, the host 10 instructs the dedicated storage facility 22 to download a copy of the page as appropriately structured, to the requesting mobile phone 20, and to augment this with the context dependent dynamic data 24 (which once again may be located at any suitable location within the network) and this step is represented schematically at processing stage 26, although it could take place at the dedicated storage facility 22, at the storage location of the dynamic data, or at the device, among many other suitable places within the network. In the present example of a web page providing railway timetable information, the dynamic data constitutes the numerical values for the times of trains on a particular day of the week . In a further step of the process, not illustrated specifically in FIG. 1, the augmented content (i.e. the content when augmented by the dynamic data) is then modified further where appropriate to take account of minor differences of the requesting device from that of its generic class, this process taking place at any suitable location within the network between the storage of the device specific adaptations and the requesting device, including where appropriate at either of these entities.

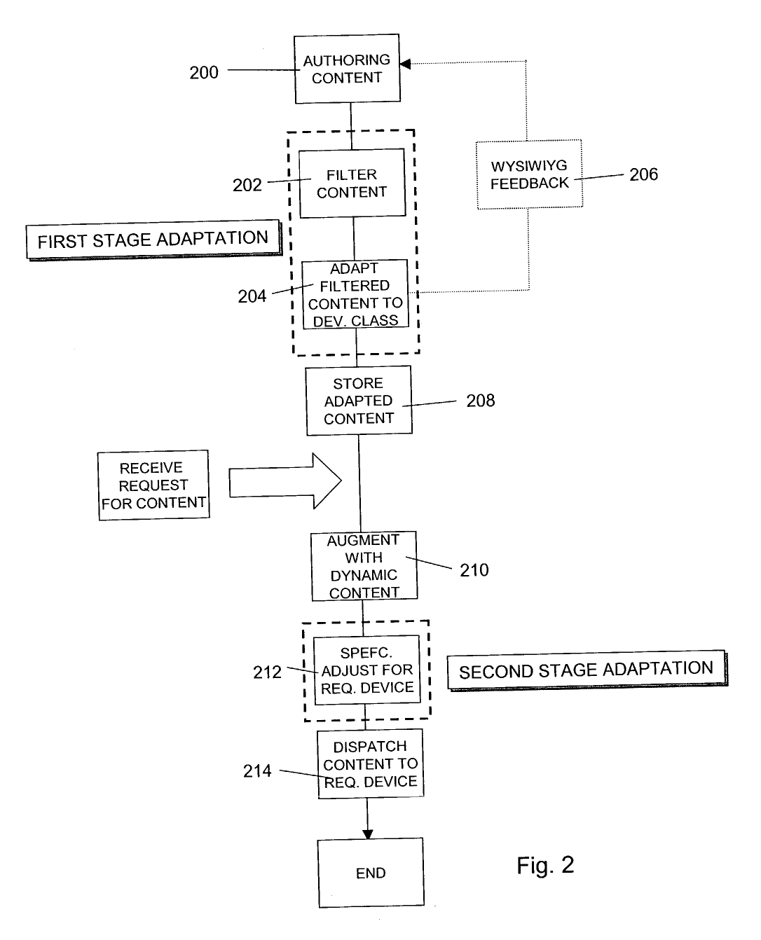

Thus, referring now to FIG. 2, in summary, an embodiment of process according to the present invention includes, at step 200 the authoring of the content, which at least includes the process of incorporating within the content machine-readable structure which is independent of device specification on which the content is to be manifested. This step is followed, at step 202, by the process of filtering the content for the particular class of device on which the content is to be manifested, so that for example non-essential elements of the content can be omitted in the case of limited capability devices, and at step 204 the filtered content is adapted to the specific class of device. Preferably, when authoring the content, it is useful to have at least some idea of how the content will be manifested as a result of decisions taken during the authoring process. At step 206 the device-specific adapted content is manifested to the author to provide this information, most preferably in What You See Is What You Get (WYSIWYG) form, so that the author is able to assimilate exactly the manner in which the content will be manifested. Following device-specific adaptation, the adapted content is stored at a suitable location within the network at step 208, from which it is retrieved and sent to a requesting device on receipt of a request, whereupon it is augmented with the dynamic component of the content at step 210. At step 212 the augmented dynamic content is dispatched to the receiving device (although steps 210 and 212 are optionally interchangeable in order as desired depending upon factors such as where they take place), and at step 214 any minor adaptations for the specific device are performed (although this step is interchangeable in order with step 212 depending upon where it takes place).

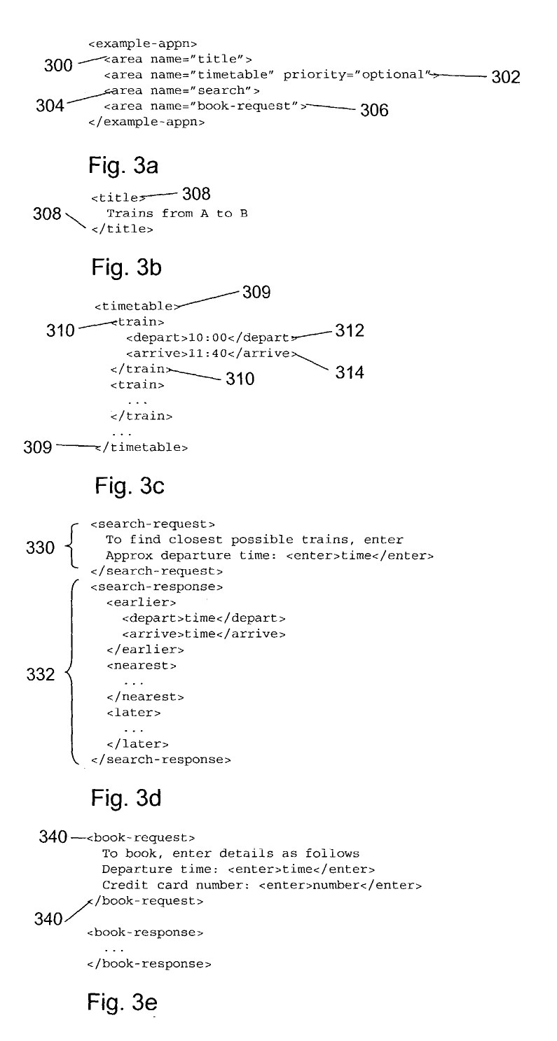

Referring now to FIG. 3, an example of the content for the present example of a web page displaying a railway timetable is illustrated. In this example, for the purposes of illustration, much of what may be termed the “literary work”, i.e. the words, has been omitted, since this is not necessary in order to illustrate the principles involved, leaving only sufficient to enable an understanding of the role of the tags which code machine-readable structure into the content, here in a computer language known as Extensible Markup Language (“XML”). Referring to FIG. 3a, the content of the web page has four sections, or chapters: a title section denoted by the XML tag 300, a timetable section, in which the full timetable is stored, denoted by a tag 302 (which it should be noted additionally denotes the optional, i.e. non-essential nature of the timetable), a search request section which enables a user to search for particular train departures which is denoted by tag 304, and a book requesting section which enables a user to book a ticket for a particular train, and which is denoted by a tag 306.

The nature of the title section 300 is illustrated in FIG. 3b, and simply includes the words “Trains From A to B”, delimited by the pairs (indicating the start and end of the title) of <Title> XML tags 308. The timetable section is illustrated in detail in FIG. 3c, and its limits are denoted by a pair of <Timetable> tags 309, and includes nested within it a plurality of subsections, each of which is denoted by a pair of <Train> tags 310 which each in turn contain pairs of <depart> and <arrive> tags 312 and 314 respectively denoting the limits of the numerals relating to the departure and arrival times within them. The <Search> section shown in FIG. 3d has two subsections: a <search-request> section denoted by tags 330, and which contains text indicating the procedure for performing a search to a user, together with further tags denoting the time entered by the user, and a <search-response> section, denoted by tags 332, and containing yet further nested sections relating to the various train times that the search has located, such as the nearest departure time found to the departure time sought, and departure times earlier and later than the time sought. Finally, in FIG. 3e, the <book> section 340 includes book request section containing text instructing a user to enter data, and further tags which denote the numbers entered by the user as the time of travel and a credit card number respectively, while the <book-response> section does not, in the illustrated include anything, in practice this is likely to include text such as for example “Thank you for your booking”.

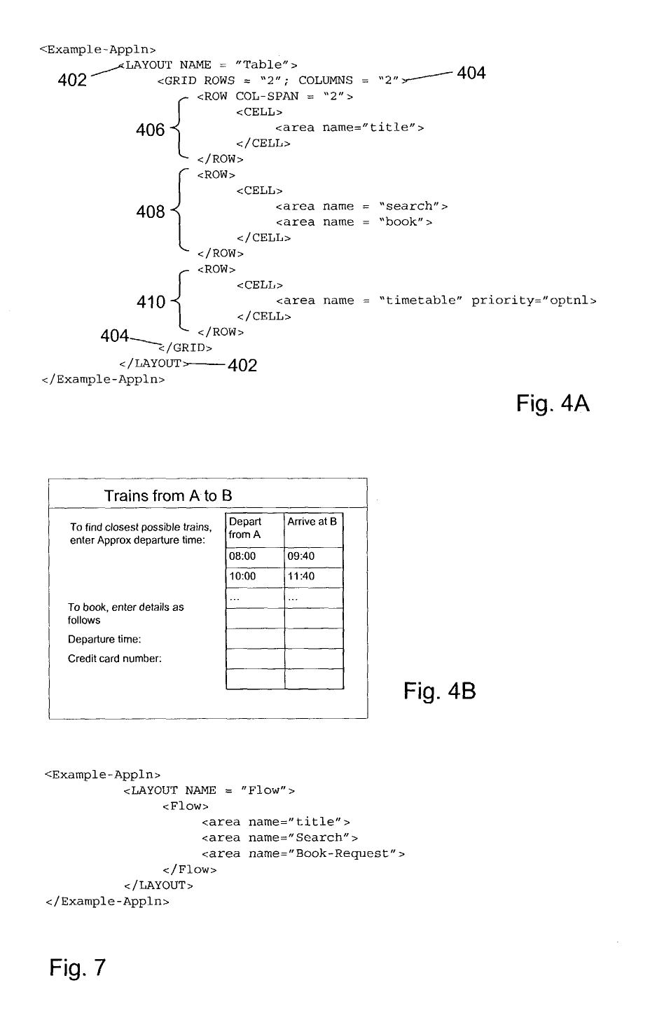

FIG. 3 thus shows the content in what may be thought of as its rawest form; it includes the text, and the machine readable commands, which in this case are XML tags to provide machine readable structure corresponding to that implicit within the text by virtue of its meaning. The content as illustrated in FIG. 3 is thus simply a series of structural modules, and beyond denoting the individual modules as such does not reflect any of the author's intentions regarding the manner in which the text should be laid out when displayed to a user. In order for an author to provide an indication of the layout of the content when displayed, instructions relating to the desired layout of the content must also be coded into the content in machine readable form. Referring now to FIG. 4, the content of FIG. 3 is shown incorporating device-independent machine readable instructions reflecting the author's desired layout, referred to herein as layout markup code. In the present invention the layout markup code is also provided by XML, although any device independent language will be suitable. All elements of the content referred to above in relation to FIG. 3 are shown in FIG. 4, namely the Title 300, Timetable 304, Search 306 and Book 308 sections are all included, since this is the author's preferred form of display (and self-evidently the author is going to prefer to have all elements of the work they have authored and which are available on the site to be displayed on the page). NB. In FIG. 4a for example the elements are included by simply displaying the tags denoting their headings, but this is a shorthand way of incorporating all of the content which corresponds to that header at the location in which the header is located within the code of FIG. 4a. All of the content shown in FIG. 3 is encompassed between a pair of <Layout> tags 402, the attributes of the first of which indicate that the layout is to be a table, and within which a further pair of <Grid> tags 404 indicate that the table is to be constructed around a grid, with the first of these tags indicating that the table will have a width of two columns, and a height of two rows. Each of the sections is then tagged with a position within the table, so that for example the <Title> section will be situated in a cell located in a row which extends across two column widths, as denoted by the attributes of the first of the two <Row> tags defining the part 406, while the <Search> and <Book> sections are located in cells each located in different rows of their respective column, as denoted by the <Rows> tags 408, and the <Timetable> section is located in a separate cell of content and within rows of the table located in the second column, as denoted by the tags 410. Referring now to FIG. 4b the content (which will in practice also include dynamic content which augments it as outlined in step 210, here for example train times when search results are displayed) is illustrated in tabular form corresponding to the markup instructions of FIG. 4a.

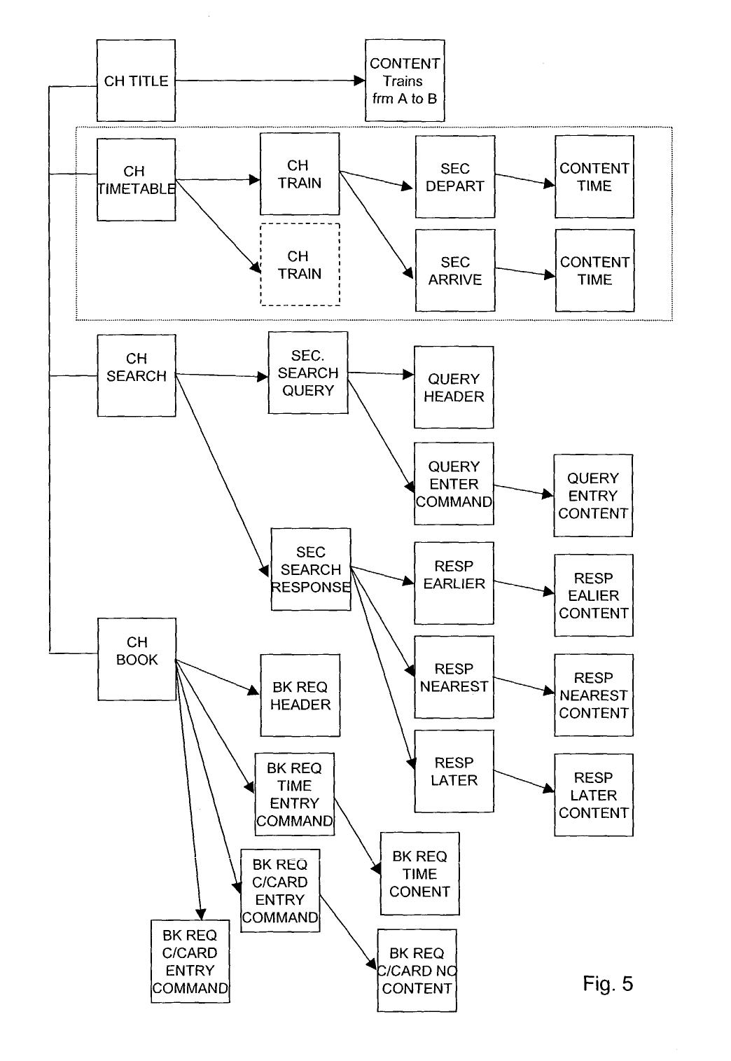

Referring now to FIG. 5, the structure of the content as illustrated in FIGS. 3 and 4 may be represented in a graphical form, which may be also used to illustrate the first part of the process of adaptation of the content into device specific form, namely the filtering of content to remove non-essential parts for low-capability devices, shown as step 202 in FIG. 2. In FIG. 4a, the relatively simple structural nature of the content can be seen, and it can likewise be seen that the only non-essential content is the entire <Timetable> section, since it is not necessary to be able to see all of the trains for a particular day in order for example to search for trains at a particular time, or book a ticket for a train at a particular time. The non-essentiality of the content it may be recalled is denoted by the “attributes” (i.e. the text within the tag) of the XML tag denoting it, and so where parts of a particular section of content are non-essential they will likewise be denoted as such by the attribute, and filtered out accordingly by the filtering part of the adaptation software (from which it follows, in the present example is capable of “reading” XML). The processing of filtering the content illustrated in this example has resulted in the removal of an entire “branch”, but, depending upon the instructions coded into the machine readable structure of the content relating to the optional nature of given elements of the content, the filtering process may instead remove a given layer from each branch in the structural hierarchy for example, rather than an entire branch.

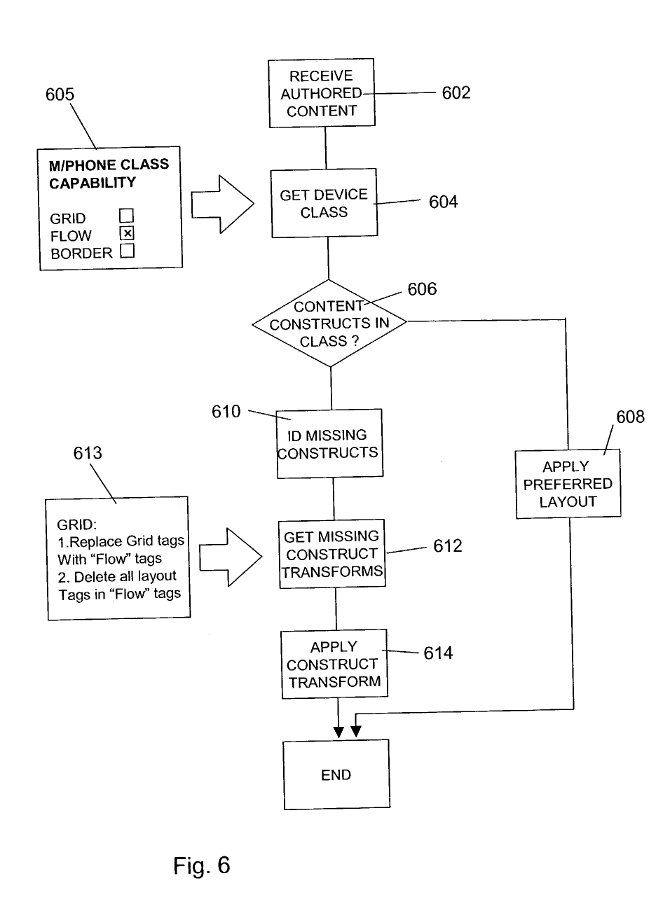

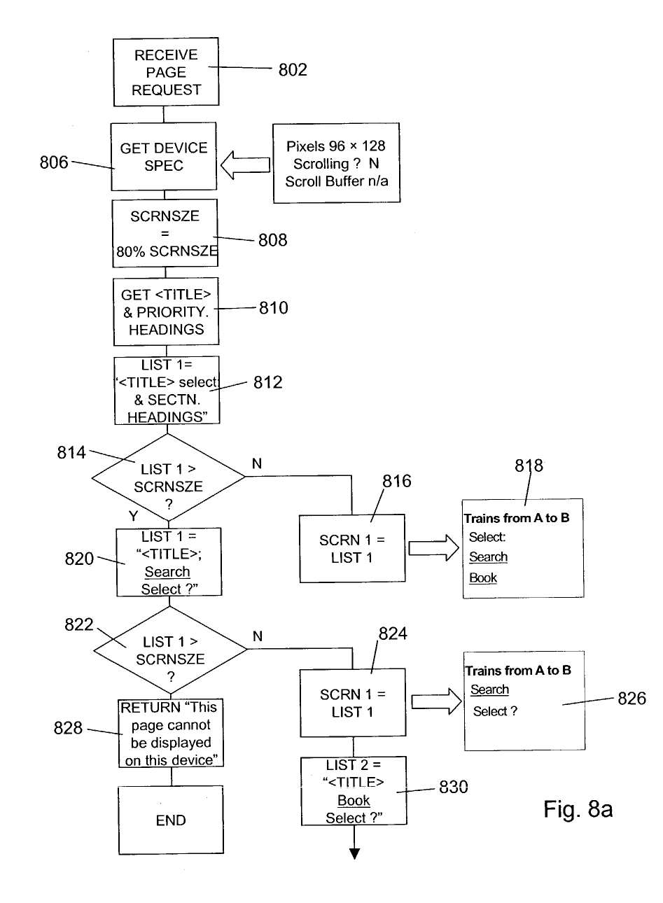

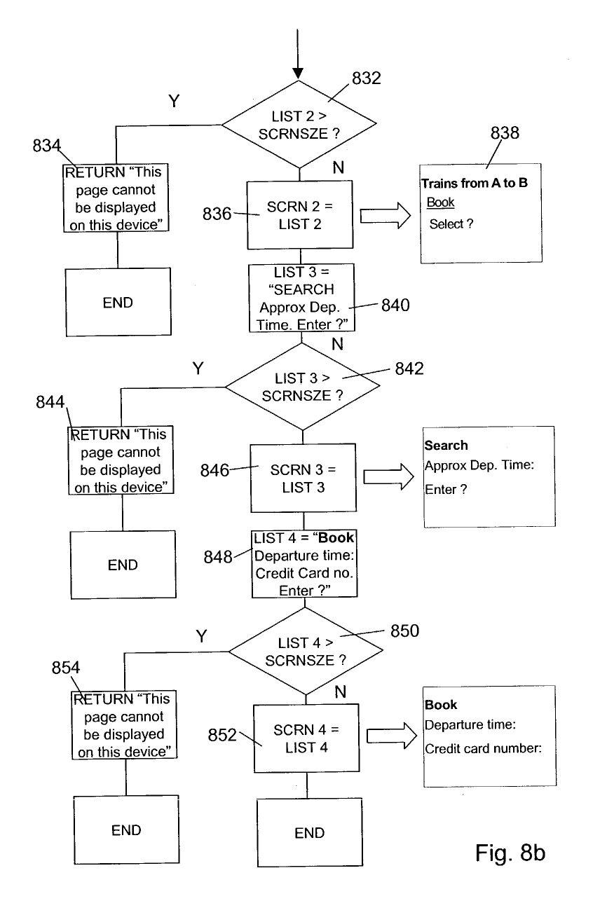

Once the content has been filtered, the second part of the adaptation process, summarised at step 204 in FIG. 2 is then performed, namely adapting the filtered content including the layout markup code for the particular classes of device. Referring now to FIG. 6, this process is initiated at a step 602 by the reception of authored content, whereupon the device class specification for the particular device for which the content is to be adapted is then retrieved from memory at step 604. The retrieved device-class specification 605, in this instance the specification for a mobile phone, indicates the capabilities of the device which are relevant to interpreting the applicability of the layout markup code for that class of device, and so in the present example indicates that the phone is not capable of GRID formatting, but can deal with FLOW formatting, and is not capable of dealing with format instructions relating to BORDERS. At step 606 within the process, the programme performing the adaptation process determines whether all of the constructs of the layout markup code which provides the layout information in the preferred form of the content shown in FIG. 4 are in the specification of that particular device class as retrieved at step 605. In the event that they are, the at step 608 the author's preferred layout is simply then applied using the author's preferred layout markup code. If however there are constructs within the preferred layout markup code which are not in the device class specification, then at step 610 the programme identifies these constructs, in this example the “GRID” construct, and at step 612 retrieves a predetermined transformation 613 for replacing the construct absent from the device class specification with ones that are present. As can be seen from FIG. 6, the transformation for replacing GRID constructs (absent from the device class specification) with FLOW constructs involves replacing the GRID tags with FLOW tags, and deleting all remaining layout markup code within the FLOW layout tags. At step 614 this transformation is applied to the preferred form of content, and this yields a revised form of content suitable for a mobile phone, and which is shown in FIG. 7.

The second part of the adaptation process also includes the step of adapting the filtered and generically adapted content to the specific device requesting the web page (as opposed to adaptation to a class described in the previous paragraph), and an example if this will now be described in detail with reference to FIGS. 8a and 8b. The process starts at step 802 with receipt of a request for the page by the mobile phone. The specification for the specific device requesting the page is then obtained at step 806 from the device itself in the course of the transaction to request the page, and it can be seen from the present example that this includes, inter alia the phone screen size in pixels, whether it has scrolling capability on its screen, and the size of its scroll buffer in the event that it does. At step 808 a variable SCRNSZE, denoting the size of the screen of the phone is initialised with a value of 80% of the screen size given in the device class specification (effectively to provide margin for error). At step 810, the part of the adapted form of the document shown in FIG. 7, and denoted by the XML tags <Title> is retrieved, together with other priority (i.e. non-optional items filtered out by the process illustrated in FIG. 5) headings, and at step 812 the programme generates a list (given the name LIST 1) of the text item <Title>, word “select?”, and the other section headings (which act therefore as menu options) on what may be thought of as a virtual screen, in order to determine the amount of screen that such a list will take up. At step 814 a decision step determines whether the list on the virtual screen is less than the variable SCRNSZE which is defined as the screen size of the class of mobile phone, if it is, then at step 816 the list LIST 1 is stored as the first display screen (SCRN 1) for the phone, and an image of this first screen is shown at item 818. If however the size of LIST 1 is not less than the defined screen size, then at step 820, the virtual screen of LIST 1 is redefined, dropping the last item (as indicated by the XML tags) from the previous incarnation of LIST 1, thereby reducing its size. A further decision step 822 at which it is determined whether the newly redefined LIST 1 is smaller than the variable SCRNSZE is then performed. If the new LIST 1 is smaller than SCRNSZE then that incarnation of LIST 1 is defined as the first display screen SCRN 1 at step 824, shown at item 826. If however LIST 1 is still too large, then the programme returns an error message at step 828, since it is not possible to generate a meaningful list which is smaller in size than the list LIST 1 from step 520, whereupon the programme ends. In practice this error message will be activated by the programme performing a series of decision steps after each occasion on which the screen is too small for the LIST under consideration to determine number of section headings on the screen (which may be identified from the tags which define them), and triggering the error message when there is only one remaining and the screen size is still too small, so that it is not possible to display anything having sufficient meaning on the screen. Following the adoption of LIST 1 as the first screen at step 824, a second list, LIST 2 is generated at step 830 with the remaining items from the original LIST 1 which were removed in the reconfiguration of step 820, namely the <Title>, the heading “Book” and the “select?” command. Step 832 determines whether LIST 2 is larger than SCRNSZE, and if it is returns, at step 834, the error message discussed in connection with step 828; if it is not then at step 836 LIST 2 is adopted as the second display screen SCRN 2 and illustrated at item 838.

The programme continues in this manner, generating lists from virtual screens and checking their size against the available screen size in order to determine whether the text on the virtual screen will fit on a single screen of the mobile phone, until all of the content has been processed in this way, with the search pages being processed at steps 840, 842 and 846, and the booking pages at steps 848, 850 and 852.

As mentioned above, the present invention has been exemplified by reference to requesting a web page displaying text using a mobile phone. The methods of the present invention are however widely applicable to a variety of types of content hosted at a variety types of network location.

1. A method of disseminating media content, hosted at a site within an information technology network, to one of a plurality of different classes of device connected to the network, the different classes of device having different capabilities for manifesting the content, the method comprising the steps of:
authoring the content by at least structuring the content in a manner which is independent of device on which the content is to be manifested;
adapting the authored content to make the content suitable for manifestation on a given class of device;
storing the adapted content at a location within the network; and
upon receipt of a request for a copy of the content, augmenting the adapted content with dynamic content.

2. A method according to claim 1 wherein the content includes literary works, and the dynamic content comprises visual characters to be included at a particular point in the structure of the adapted content.

3. A method according to claim 2, wherein the method further comprises the step, during authoring, of providing a manifestation of the authored content post-adaptation to make the content suitable for manifestation on a given class of device.

4. A method according to claim 1 further comprising the step of further adapting the content to adjust the adapted content for capabilities of an individual device on which the content is to be manifested.

5. A method according to claim 1 wherein the content includes text, and the process of authoring the content includes the provision within the content of machine readable code providing an indication of layout of the text desired by the author.

6. A method according to claim 5 wherein the step of adapting the content includes the step of transforming any machine readable instructions relating to layout of the text which are not implementable on a given device class, into instructions which are thus implementable.

7. A method according to claim 1 wherein the step of adapting the content includes the step of filtering out elements of the content.

8. A method according to claim 7 wherein the filtering step removes elements of content which are not capable of manifestation on the given class of device.

9. A method according to claim 1 wherein the content is adapted to be suitable for a device selected from the group consisting of: a mobile telephone, a PDA and a desktop computer.

10. A method according to claim 1 wherein the content includes at least one of:
music, images including photographic images, moving images and text.

11. A method of authoring content for hosting on a site within an information technology network to enable dissemination of the content to one of a plurality of different classes of device connected to the network, the method comprising the steps of:
structuring the content in a manner which is independent of device implementation;
adapting the content as structured in device independent form to make the content suitable for manifestation on a given class of device; and
during structuring of the content in device independent form, manifesting the content as it will appear when manifested on a given class of device.

12. A method of manifesting a web page stored on a server on a computing entity connected to the server via network, comprising the steps of:
creating a work including at least one of: literary work, musical work, graphical work, moving images;
creating content from the work by embedding with the work machine-readable instructions reflecting semantic structure of the work;
upon receiving a request for the content from a specific class of computing entity, adapting the content to enable its manifestation on the specific class; and
augmenting the content with material which is contemporaneous to a time at which the content was requested.
